(19) United States
(12) Patent Application Publication
(10) Pub. No.: US 2026/0318748 A1
(43) Pub. Date: Oct. 15, 2026

(54) BREAKABLE TEMPERATURE SENSOR WITH ROHS-COMPLIANT FIXING DROP

(71) Applicant: Yageo Nexensos GmbH, Kleinostheim (DE)

(72) Inventors: Stephan Urfels, Kleinostheim (DE); Roland Reul, Kleinostheim (DE); Thomas Loose, Kleinostheim (DE); Tim Asmus, Kleinostheim (DE); Tobias Droste, Kleinostheim (DE)

(21) Appl. No.: 19/489,435

(22) PCT Filed: May 28, 2024
(86) PCT No.: PCT/EP2024/064646

§ 371 Date: Dec. 2, 2025

(30) Foreign Application Priority Data
Jun. 2, 2023 (EP) 23176884.7

(51) Int. Cl. G01K 1/08; C03C 3/093; G01K 7/16; H01C 17/065

(52) U.S. Cl. CPC G01K 1/08; C03C 3/093; G01K 7/16; H01C 17/06533

(57) ABSTRACT

Glass compositions, in particular fixing drops, for relieving strain in connection wires on a passive component, a method for the production of wired passive components, a passive component obtainable by this method, as well as to the use of such glass compositions for relieving strain in the connection wires on passive components.

### CROSS REFERENCE TO RELATED PATENT APPLICATIONS

This is a U.S. national phase patent application of PCT/EP2024/064646 filed May 28, 2024, which claims the benefit of and priority to European Patent Application No. 23176884.7 filed on Jun. 2, 2023, the entire contents of each of which are incorporated herein by reference for all purposes.

### TECHNICAL FIELD

The present invention relates to glass compositions, in particular fixing drops, a passive component, a method for the production of a passive component, a passive component obtainable by this method, as well as the use of such glass compositions for relieving strain in the connection wires on passive components.

### BACKGROUND

“Passive components” should as a rule be understood to mean those components which, in contrast to active components, do not demonstrate an amplification effect and do not have a control function. Examples of passive components are resistors, capacitors, sensors and heaters, for example.

In the context of the invention, a passive component preferably comprises a substrate, a multilayer structure which is located on the substrate, at least one connection wire and a glass composition for relieving strain in the at least one connection wire. The multilayer structure in turn preferably comprises at least one connection pad to which the at least one connection wire is fixed, at least one electrical strip conductor, and at least one dielectric layer, for example a screen-printed glass layer, which is disposed between the glass composition and the substrate and covers the strip conductor but leaves the connection pad substantially free.

The glass composition, in particular fixing drop, is primarily used to relieve the strain on at least one connection wire. This on the one hand ensures that the at least one connection wire is securely fixed and, on the other hand, the glass composition protects the areas it covers from possible external influences such as moisture which condenses out of the air, for example. Furthermore, the glass composition also has a protective function and so, for example, the glass composition can protect the connection wires from an electrical short-circuit by contact with a conductive housing.

Individual production of passive components is usually too costly for mass production. Consequently, for the mass production of passive components, several structures are disposed on a common substrate, wherein at least one connection wire is mechanically fixed to the respective structure. The connection wires are relieved of strain by the application of a contiguous glass composition, which extends as a contiguous layer over several structures and at least partially covers them. The subsequent singulation of the components then comprises severing of the substrate and the glass compositions.

A variety of options exist for singulating the passive components, wherein as a rule the passive components are singulated by sawing. This procedure does in fact involve additional expenditure, particularly if the passive components comprise a hard substrate, for example based on Al₂O₃, however it can be used irrespectively of the glass composition and is associated with low failure rates. Alternatively, singulation by breaking is much less labor-intensive and is therefore more cost-effective. However, this method is associated with the challenge that the breaking of glass is often associated with higher failure rates.

Because most glass compositions do not break in a defined manner, glasses which have not been optimized for this type of singulation have oblique break surfaces, or the break is in the wrong place, i.e. not through the predetermined breaking point in the substrate. A glass composition which could withstand the tensile stresses which act on the fixing upon breaking for long enough for the predetermined breaking point in the substrate to break first, and which would therefore determine the breaking position in the glass composition, would be advantageous. A glass composition with a high elasticity, i.e. a Young's Modulus of approximately 45 GPa or less, is particularly advantageous for this type of fracture toughness.

Preferably, the glass composition in accordance with the invention has a modulus of elasticity of 45 GPa or less.

The term “break surface” should be understood to mean the new surface of a passive component formed by the singulation. In this context, microcracks or flakes on the break surface can be mentioned by way of example. Furthermore, the microcracks can also propagate into the interior of the glass composition, in which they are very difficult to detect. Passive components with such poorly broken glass compositions are often not suitable for further use. What is worse is damage (probably microcracks) in the interior of the glass composition which arises upon breaking because of the mechanical stress over the wires, where the glass composition is thinnest. These cannot be detected optically and only propagate through the bulk of the glass in the event of thermal stress on the component. Fine hairline cracks can then be seen over the connection wires.

Lead-containing glass compositions known from the prior art have advantageous mechanical stability, good electrical properties and good breaking properties. This stems from a particularly advantageous production method, namely that the glass composition can be applied over the connection wires as a contiguous strand and subsequently, the passive components can be singulated without reaching failure rates which are too high due to incorrectly broken glass or glass which has been broken at the wrong place.

However, lead-free glass compositions are required for environmental protection. As a result of this, the EU has restricted the use of certain dangerous substances in electrical and electronic appliances by means of the RoHS Directive. In particular, the specified upper limit for lead of 1000 ppm therefore demands that existing glass compositions must be appropriately modified for use in the cited technical applications.

A fundamental problem which arises when providing lead-free glass compositions is therefore in replacing the lead-free components and at the same time retaining the advantageous properties, in particular the good breaking properties.

One option for circumventing at least the requirement for breakability would be to attach the glass composition to the connection wires only at certain points, so that the glass composition would not have to be severed. While this approach would be possible in principle, it would involve additional effort and would therefore offset the process and cost advantage gained by avoiding sawing through.

Lead-free but alkali-containing glasses indeed exhibit good breaking properties but, however, are not suitable for use as a glass composition for passive components. One problem which increasingly arises with such glasses is the occurrence of polarization effects, which are also known as capacitance effects, which are described, for example, in US 2021/0396590 A1, which is incorporated herein in its entirety. In the context of the application, the term “polarization effects” should in particular be understood to mean that a charge separation occurs at the connection wires in the glass composition. When an electric current is applied, this consequently leads to a deviation in the measured electric voltage from the stationary value. This voltage difference will be termed below as the “voltage offset”. Because the polarization effect, and therefore the voltage offset, does not vary in a linear manner as a function of temperature, it is not possible to take this into account by means of a factor.

The magnitude of the measured polarization effect is dependent upon the exact measurement method or the measuring period and can be determined in accordance with the following measurement method:

The resistance of the passive component, in particular of the temperature sensors, is measured in two ways.
a) Measurement with reversal of voltage.
A voltage of +250 mV is applied, any capacitors present become charged thereby and the resistance is measured after one minute.
Then the polarity of the voltage is reversed and measured afresh one minute after the reversal. A first mean value is formed from both measurements. Any thermoelectric voltage which might be present is computationally compensated for thereby. The temperature 1 of the sensor is measured from the mean value of the two measurements.
b) Rapid measurement with separation of the voltage source.
Here, the sensor in the measuring instrument is separated internally from the voltage source every 0.2 s, the input voltage then present is measured and computationally subtracted from the measured voltage. Any thermoelectric voltage that might be present is also compensated for thereby. Here again, the resistance is measured after approximately one minute, the voltage is reversed and measured afresh after a further minute and a second mean value is formed. A temperature 2 is determined from this second mean value.

Consequently, in the context of the present disclosure, the polarization effect will be given below as the difference between temperature 1 and temperature 2.

If the difference is over 0.5° C., the polarization effect is assessed as being strong.

Particularly at high temperatures, the voltage offset can be so large that the tolerance classes required for passive components cannot be complied with over the entire temperature range. This is particularly the case for wired sensor elements with a resistance of more than 500 ohm. In the context of the development work for the present application, it was surprisingly established that the lithium (ion) and sodium (ion) content is primarily responsible for the strength of the voltage offset in lead-free glass compositions.

In passive components with nominal resistances of below 1000 ohm, the polarization effect is harder to measure dynamically, but this is mitigated by the accuracy of the measured values determined with the component.

In this case, the standardized polarization effect is defined by the polarization effect which results in a passive component with the same geometry of the connection wires and glass composition, but with a temperature-dependent nominal resistance of 1000 ohm between the connection wires. The designation “capacitance effect” will be used below as a synonym for the standardized capacitance effect defined in this manner. Thus, the term and the measurement protocol for the capacitance effect is extended in a reproducible manner to all passive resistances and in particular also to heaters with resistances of below 1000 ohm.

In the case of this measurement method, but also in the case of the functionality of the passive component, the substrate quality is also not insignificant, because a short circuit current can also flow over it. Particularly in the case of passive components, which contain substrates with specific resistances of over 10⁹ Ωcm (at 500° C.), the insulation resistance of the fixing drop can influence the measurement error. Thus, inter alia, Al₂O₃ substrates, MgO substrates, many glass substrates, or some doped zirconium oxide substrates, as well as their mixtures or layers, are suitable as substrates for the passive components with the glass composition in accordance with the invention.

The same is true for passive components on more conductive substrates if a sufficiently high insulation effect has been applied by at least one non-conductive layer with a sufficiently high dielectric strength between the conductive structure and the substrate.

A combination of substrate, any electrically insulating layer which is necessary and the glass composition in accordance with the invention such that a limit of 17 MΩ at 500° C. is exceeded as the total insulation resistance between the resistance pathways is advantageous for minimizing the measurement error of the components. A passive component with fixing drops is more particularly advantageously suitable for precise measurement when the insulation resistance between the resistance pathways exceeds 17 MΩ at 550° C.

Because the polarization effect leads to a reduction in the insulation resistance at high temperatures and at the same time, the resistance increases in components with electrically conductive structures with positive temperature coefficients (PTC), the combination of such structures with the glass composition in accordance with the invention is advantageous.

### SUMMARY

The objective of the present invention is to provide a glass composition which can be broken after application to a substrate and which minimizes the disadvantages cited above with this type of singulation and at the same time is without constituents which damage the environment and which impair the electrical properties. In particular, the objective of the present invention is to provide a glass composition, in particular fixing drop, for relieving strain in the connection wires on passive components on an inorganic substrate, wherein the glass composition comprises small quantities of Na and Li and less than 1000 ppm of lead.

Surprisingly, this problem was solved by a glass composition as shown and described herein, in particular by a glass composition, in particular fixing drop, for relieving strain in connection wires on passive components, in particular sensors, preferably temperature sensors, or heaters, on an inorganic substrate, in particular a metal oxide, semiconductor and/or glass substrate, wherein the glass composition comprises SiO₂, Al₂O₃, B₂O₃ and ZnO, characterized in that the glass composition comprises less than 1000 ppm lead, and in that the glass composition comprises less than 2% by weight Na, less than 0.2% by weight Li, and/or less than 2% by weight as the sum of Na and Li, respectively measured by means of ICP, and with respect to the total weight of the glass composition.

The quantities of Na and Li in this regard preferably refer to the quantity of the Na⁺ and Li⁺ ions, so that in the context of the present disclosure, Na and Na⁺, or Li or Li⁺, are used as equivalents. This applies in an analogous manner to lead, which can also be understood to mean the corresponding lead ion.

Numerous specific details are discussed below in order to provide a comprehensive understanding of the present subject matter. However, it will be apparent to the person skilled in the art that the subject matter can also be put into practice and reworked without these specific details.

All features of one embodiment can be combined with features of another embodiment, if the features of the different embodiments are compatible.

The terminology used in the description of the present disclosure should be understood to be for the purposes of describing particular embodiments only and is not intended to limit the subject matter. As used in the present description and claims, the singular forms “a”, “an” and “the” should be understood to encompass the plural forms as well, unless the context clearly dictates otherwise. The reverse is also true, i.e., the plural forms also encompass the singular forms. It should also be understood that the term “and/or” as used herein refers to and encompasses all possible combinations of one or more of the associated listed elements. It should further be understood that the terms “contains”, “encompasses”, “comprises” and/or “comprising” when used in the present description and claims specify the presence of the specified features, steps, operations, elements and/or components, but do not preclude the presence or addition of one or more other features, steps, operations, elements, components and/or groups thereof.

In the present description and claims, the terms “includes”, “comprises” and/or “comprising” may also mean “consisting of”, that is, the presence or addition of one or more other features, steps, operations, elements, components and/or groups is excluded.

The concentration of lithium, sodium and lead in the glass composition in accordance with the invention was determined by optical emission spectrometry with inductively coupled plasma (ICP-OES). The inductively coupled plasma method is based on the use of a very hot (ca. 10000 K) argon plasma in order to excite the optical emission of the elements to be analyzed. Preferably, the lead concentration is measured in accordance with the IEC 62321-5:2013 standard and the concentration of lithium and sodium is measured in accordance with DIN EN ISO 11885.

The glass composition for relieving strain in the connection wires is located on the structure in a manner such that the connection pads for the connection wires are covered.

Advantageously, the glass composition covers at least portions of an underlying screen-printed glass layer. This produces a particularly high adhesive force between the glass composition and a screen-printed glass layer. This is of particular advantage, because this means that it can be thoroughly ensured that the glass composition does not become detached from the passive component under increased mechanical loads.

Since passive components are exposed to increased temperatures during operation or due to the environment, water hammer can occur on the hot passive component, for example in a humid atmosphere. Special protective measures are usually necessary in order to avoid the temperature shock on the surface of the passive component.

Advantageously, these additional protective measures can be dispensed with in the case of the glass composition in accordance with the invention, since this has a low thermal conductivity. This property is particularly advantageous in the case of the preferred use as a fixing drop on a passive component. It is also advantageous here that the glass composition in accordance with the invention has a low coefficient of expansion in the direction transversely to the underlying screen-printed glass layer.

The glass composition in accordance with the invention is preferably characterized in that the glass composition for relieving strain in the at least one connection wire can be fused or sintered with the at least one screen-printed glass layer. In this regard, at least the constituents of the glasses may be similar or identical, or alternatively, the constituents of the glasses differ, preferably so that they cannot be sintered or fused together.

Furthermore, the glass composition in accordance with the invention is preferably characterized in that the glass composition comprises from 20 to 55% by weight, preferably from 25 to 50% by weight, silicon dioxide, from 5 to 15% by weight, preferably from 6 to 14% by weight, boron oxide, and from 4 to 18% by weight, preferably 5 to 17% by weight, aluminum oxide, with respect to the total weight of the glass composition.

More preferably, the glass composition in accordance with the invention additionally comprises from 5 to 14% by weight, preferably from 6 to 13% by weight, zinc oxide, with respect to the total weight of the glass composition.

Because the glass composition in accordance with the invention may be a non-homogeneous mixture, the percentages by weight which are given refer to the respective average content in the glass composition or the fixing drop. Local deviations in the percentages by weight in the glass composition or in the fixing drop are possible, but average out to the percentages by weight that are given.

Furthermore, the glass composition in accordance with the invention is preferably characterized in that the glass composition comprises from 35 to 55% by weight silicon dioxide, from 9 to 14% by weight boron oxide, from 6 to 9% by weight zinc oxide, from 4 to 7% by weight strontium oxide, from 2 to 5% by weight potassium oxide, or from 35 to 55% by weight silicon dioxide, from 8 to 15% by weight bismuth oxide, from 6 to 11% by weight boron oxide, from 6 to 10% by weight zinc oxide, from 4 to 8% by weight strontium oxide, from 2 to 6% by weight potassium oxide, or from 20 to 55% by weight silicon oxide and lanthanum oxide, from 11 to 14% by weight boron oxide, from 9 to 13% by weight zinc oxide, from 3 to 6% by weight calcium oxide, respectively with respect to the total weight of the glass composition.

Furthermore, the glass composition in accordance with the invention is more preferably characterized in that the glass composition comprises from 35 to 55% by weight silicon dioxide, from 9 to 14% by weight boron oxide, from 6 to 9% by weight zinc oxide, from 4 to 7% by weight strontium oxide, from 2 to 5% by weight potassium oxide, or from 35 to 55% by weight silicon dioxide, from 8 to 15% by weight bismuth oxide, from 6 to 11% by weight boron oxide, from 6 to 10% by weight zinc oxide, from 4 to 8% by weight strontium oxide, from 2 to 6% by weight potassium oxide, or from 20 to 55% by weight silicon oxide and lanthanum oxide, from 11 to 14% by weight boron oxide, from 9 to 13% by weight zinc oxide, from 3 to 6% by weight calcium oxide, respectively with respect to the total weight of the glass composition.

Because it is not possible to take the polarization effect into consideration in most cases and measuring means environments, it is desirable to use glass compositions which only exhibit a small polarization effect. As discussed above, low concentrations of sodium and lithium in the glass composition result in a small polarization effect, and therefore it is particularly advantageous for the glass compositions to have only small quantities of these elements. Furthermore, lithium acts as a poison as regards platinum and is therefore preferably contained in the glass composition in accordance with the invention in particularly small quantities.

Furthermore, the glass composition in accordance with the invention is preferably characterized in that the glass composition comprises less than 2.0% by weight Na or less than 1.9% by weight Na or less than 1.8% by weight Na or less than 1.7% by weight Na or less than 1.6% by weight Na or less than 1.5% by weight Na or less than 1.4% by weight Na or less than 1.3% by weight Na or less than 1.2% by weight Na or less than 1.1% by weight Na or less than 1.0% by weight Na or less than 0.9% by weight Na or less than 0.8% by weight Na or less than 0.7% by weight Na or less than 0.6% by weight Na or less than 0.5% by weight Na or less than 0.4% by weight Na or less than 0.3% by weight Na or less than 0.2% by weight Na or less than 0.1% by weight Na.

Particularly preferably, the glass composition in accordance with the invention comprises less than 2.0% by weight Na or less than 1.5% by weight Na or less than 1.0% by weight Na (respectively determined by means of ICP-OES, with respect to the total weight of the glass composition).

In particular, the glass composition in accordance with the invention is characterized in that the glass composition comprises less than 1.5% by weight Na (determined by means of ICP-OES, with respect to the total weight of the glass composition).

Furthermore, the glass composition in accordance with the invention is preferably characterized in that the glass composition comprises less than 0.2% by weight Li or less than 0.15% by weight Li or less than 0.1% by weight Li or less than 0.05% by weight Li (respectively determined by means of ICP-OES, with respect to the total weight of the glass composition).

Consequently, the glass composition in accordance with the invention is preferably further characterized in that the glass composition comprises less than 1.5% by weight as the sum of Na and Li, preferably less than 1.0% by weight as the sum of Na and Li, respectively determined by means of ICP-OES, with respect to the total weight of the glass composition.

Although the avoidance of lithium and sodium in the glass composition has been shown to be a successful strategy, in order to reduce the polarization effect to a minimum, the occurrence of the polarization effect may alternatively be determined experimentally. To this end, a current-voltage curve for a passive component may be recorded with the glass composition to be investigated, wherein an initial voltage is applied which is increased in steps to a final voltage. Subsequently, the voltage is reduced from the final voltage to the initial value. If the current that is measured thereby when the voltage is being decreased takes values other than those when the voltage was being increased, this will be visible in the current-voltage curve in the form of a hysteresis. A hysteresis in the current-voltage curve is therefore an indication of a polarization effect in the glass composition. Even if in the ideal case, no hysteresis can be observed, under some circumstances, a certain amount of deviation from ideal behavior can be tolerated.

The insulation resistances between two connection wires on a passive component without strip conductors can be measured as a further indication as to whether a glass composition encourages the polarization effect in a specific temperature range. The term “passive components with low resistances”, in particular with resistances below 500 ohm, and in particular in the case of heaters, is the more reasonable option for assessing the polarization effect.

Furthermore, the glass composition in accordance with the invention is preferably characterized in that the glass composition has an absolute polarization effect of less than 0.5 K at temperatures of 500° C. to 550° C., in particular less than 0.1 K at temperatures of 500° C. and/or less than 0.3 K at temperatures of 550° C.

The glass composition is preferably electrically insulating and suitable for insulation in the case of an applied electric field strength of at least 3 V/cm, preferably at least 4 V/cm, in particular at least 5 V/cm, at room temperature.

The glass composition is preferably electrically insulating in the case of an applied electric field strength of at least 3 V/cm, preferably at least 4 V/cm, in particular at least 5 V/cm, at 550° C.

In particular, the electrical insulation is also designed for the application of alternating voltage and/or pulsed DC voltage.

In the preferred embodiment, the glass composition is very fine-pored and homogeneous on a small scale of 0.1 mm, so that an insulation value of 17 MΩ is maintained between two wires with a respective wire cross section of less than 0.0625 mm² with a separation of the wires with respect to each other of at most 0.4 mm, preferably of at most 0.3 mm, particularly preferably of at most 0.2 mm, over a length of at least 0.5 mm.

In a preferred embodiment of the invention, the wires are round wires. In another embodiment of the invention, the wires are flattened at the points or the wires taper in at least one dimension of the cross section.

In another embodiment of the invention, the wires are flat wires.

The present invention further concerns a passive component, in particular a sensor, preferably a temperature sensor, or heater.

The present invention further concerns a passive component, in particular a sensor, preferably a temperature sensor, or heater, comprising connection wires and an inorganic substrate, in particular a metal oxide, semiconductor and/or glass substrate.

The present invention further concerns a passive component, in particular a sensor, preferably a temperature sensor, or heater, comprising connection wires and an inorganic substrate, in particular a metal oxide, semiconductor and/or glass substrate, characterized in that the connection wires are strain-relieved by the applied glass composition in accordance with the invention.

Singulation by breaking has established itself as a particularly economical method for passive components. This separation method has been shown to be advantageous when predetermined breaking points are present in the substrate, thus enabling easy breaking, in particular in the case of hard substrates.

The passive component in accordance with the invention is further preferably characterized in that the passive component was obtained by singulation, wherein the singulation comprises breaking, in particular at at least one predetermined breaking point.

Even though singulation by breaking is preferable to sawing from the point of view of procedural economics, some challenges have to be met in providing suitable glass compositions which are suitable for this method.

In particular, the occurrence of critical crack formation should preferably be reduced to a minimum in order to reduce the failure rate during production.

The passive component in accordance with the invention is further preferably characterized in that the glass composition has minimal critical crack formation when the passive components are singulated.

In the context of the present invention, crack formation is characterized with the aid of the cutting angle. When the passive components are singulated, at least two passive components are separated from one another by breaking. The break surface formed in this way on one of the passive components is ideally perpendicular to the substrate plane, so that the four cutting angles between the break surface and the substrate plane are all 90°. Since adjacent angles add up to 180°, it is not necessary to take all angles into account, but the crack formation can be qualified by specifying the smallest cutting angle. Under real conditions, however, the passive components do not break ideally, but considerable deviations can occur. These deviations are tolerable, but it is advantageous if critical crack formation and microcracks in the glass composition are avoided, so that the failure rate during the manufacture of the passive components is reduced to a minimum.

“Critical crack formation” should therefore be understood to mean that the smallest cutting angle between the break surface and the substrate plane of the passive component is less than 45°.

It is therefore preferred that the smallest cutting angle between the break surface and the substrate plane of the passive component is more than 45°, preferably 60°, more preferably more than 70°.

The term “microcracks” covers fine cracks in the glass composition that are difficult to detect. These microcracks can occur when the glass composition breaks and are detected, for example, by optical inspection after the passive components have been manufactured.

The passive component in accordance with the invention is further preferably characterized in that the passive component is a temperature sensor, which complies with the range of validity of tolerance class F0.3 (B) at a temperature of −70° C. to 500° C.

Further preferred embodiments of the passive component in accordance with the invention comply with the tolerance class F0.3 (B) at a temperature of −70° C. to 500° C.

In a further embodiment of the invention, at least one respective end of at least two connection wires is encased at least in sections by means of a contiguous glass element formed by the applied glass composition.

In particular, a “contiguous glass element” should be understood to be a glass element of the type that has sections which have not been separated from each other. Moreover, in the production method, the glass element is formed by a glass material which is applied contiguously.

In other words, two connection wire ends are at least partially encased by the contiguous glass element forming the applied glass composition. The “two ends of the connection wires/of the two connection wire ends” means the ends which are disposed in physical proximity with respect to each other, so that a contiguous glass element encases these two ends at least in sections, in particular completely, in the context of the lengths of the ends cited below.

In the context of the invention, a radial direction of the ends of the connection wire is also specified if the end is in at least partial contact with a further element in a radial and/or longitudinal extent, and in particular is connected to a further element. At a direct connection point with a contact surface, the end might not be encased by the glass element at this connection point, for example, so that the glass element encases the end in other radial sections which do not form a connection point, so that overall, the end is not exposed in any radial sections.

Preferably, the ends of the at least two connection wires are positioned in the glass element substantially parallel with respect to each other, in particular parallel with respect to each other. A “substantially parallel” disposition permits a deviation in the parallelism of ±3°, in particular of ±2°, in particular of ±1°.

Preferably, the ends of the at least two connection wires are positioned in the glass element substantially parallel with respect to each other, in particular parallel with respect to each other, and the ends have the same orientation. In particular, the ends of the at least two connection wires then have the same orientation when they are orientated in the same direction.

In a particular embodiment, the invention concerns an axial component. Here, the ends of the at least two connection wires in the glass element are positioned substantially parallel with respect to each other, in particular parallel with respect to each other, and the ends have the opposite orientation.

In a preferred embodiment of the invention, the ends of the at least two connection wires have a respective length of at least 0.3 mm, in particular of at least 0.5 mm, within a/the glass element.

In a particular embodiment, the overall length of the connection wires is not longer than 12 mm.

Bonding of the glass material, in particular of the glass element, to the passive component, in particular sensor, is preferably not carried out via anodic bonding to a connection site. Preferably, the bonding of the glass material, in particular of the glass element, to the passive component, in particular the sensor, is at least partially by sintering or a sintered connection.

Particularly preferably, the bonding is carried out by forming a sintered connection with molten glass fractions in the bulk of the glass element and at the interface with the passive component.

Particularly preferably, the connection wires, in particular the ends of the connection wires, are not encased by respective singulated glass elements.

Preferably, the smallest separation of the connection wires with respect to each other is less than 2 mm, in particular 1.0 mm-0.3 mm, particularly preferably 0.4 mm. In this regard, this minimum separation in particular relates to the ends of the wires which are embedded in the glass element. The separation of the wire surfaces is defined as the distance between the connection wires. In other words, the aforementioned separation is not the separation of the wire center points of the two connection wires with respect to each other.

In a further embodiment of the invention, at least one connection pad, preferably at least two connection pads, is/are formed below at least one glass element, preferably below the glass element, which serve/serves for contact with the at least two ends of the connection wires. In this embodiment, more preferably, the two connection pads are disposed in the immediate proximity of each other and have a separation of less than 0.3 mm, in particular less than 0.2 mm, most preferably less than 0.15 mm with respect to each other.

The present invention further relates to a method for producing passive components, in particular for producing the passive component in accordance with the invention. The method comprises the following steps, wherein the order of the individual steps cited below is not mandatory:
providing an inorganic substrate, in particular a metal oxide or semiconductor substrate or a glass substrate, on which a plurality of structures are disposed, in particular in a row,
forming predetermined breaking points in the inorganic substrate between the structures, in particular by means of a laser and/or by means of mechanical removal,
attaching at least one connection wire to each of the structures,
covering the connection wires by applying a contiguous glass element, in particular by applying the glass composition in accordance with the invention, over the plurality of structures,
singulation of the passive components by breaking the inorganic substrate and the contiguous glass element at the predetermined breaking points.

The above sequence of steps is not mandatory, but also comprises all technically feasible sequences. As an example, it would be possible to form the predetermined breaking points only after a contiguous glass element has been applied/attached.

In a preferred embodiment of the method in accordance with the invention, the method steps are carried out in the listed order.

In another preferred embodiment of the method in accordance with the invention, the structure comprises a screen-printed glass layer. The step of covering the connection wires by applying a contiguous glass element would then be designed as follows:
covering the structurally facing ends of the connection wires and at least partially covering the screen-printed glass layer by applying a contiguous glass element, in particular by applying the glass composition in accordance with the invention, over the plurality of structures, wherein the structures are 60%, preferably 80%, particularly preferably 100% covered. Complete coverage of the region of the connection wires over the substrate is more preferred.

Through this preferred embodiment of the method in accordance with the invention, the interface between the glass element and the screen-printed glass layer changes into a mixing zone approximately 5 to 20 μm thick. This produces a particularly high adhesive force between the glass element and the screen-printed glass layer. This is particularly advantageous in the production of passive components, as it minimizes the risk of the glass element being jettisoned during singulation by breaking the passive components. Furthermore, this can increase the electrical dielectric strength of the passive component.

All of the preferred embodiments and definitions for the passive components in accordance with the invention apply analogously to the method in accordance with the invention.

The present invention further concerns a passive component obtainable by the method described above.

The present invention also relates to the use of a glass composition as described above for the relief of strain in connection wires on passive components, in particular as described above or obtainable by the method described above.

In a preferred implementation of the use according to the invention, the passive components were obtained by singulation, wherein the singulation comprises breaking, in particular at predetermined breaking points.

The preferred embodiments discussed above for the glass composition in accordance with the invention and the passive component in accordance with the invention are also pertinent to the method in accordance with the invention, the passive component obtained by this method and the use of the glass composition.

### DESCRIPTION OF THE FIGURES

FIG. 1 shows a current-voltage curve for the measurement of the polarization effect of a passive component comprising a lead-free glass composition with a low lithium and sodium content. The current-voltage curve does not exhibit any hysteresis, leading to the conclusion that a polarization effect is absent.

FIG. 2 shows a current-voltage curve for the measurement of the polarization effect of a passive component comprising a lead-free glass composition with a raised lithium and sodium ion content. The current-voltage curve exhibits a hysteresis, leading to the conclusion that a polarization effect is present.

FIG. 3 shows a schematic representation of a passive component without a glass element for relieving strain in the connection wires. A connection pad (3) and a screen-printed glass layer (4) are located on the substrate (5). A connection wire (2) is attached to the connection pad (3).

FIG. 4 shows a schematic representation of a passive component in accordance with the invention. A connection pad (3) and a screen-printed glass layer (4) are located on the substrate (5). A connection wire (2) is attached to the connection pad (3), which is strain-relieved by a glass composition (1).

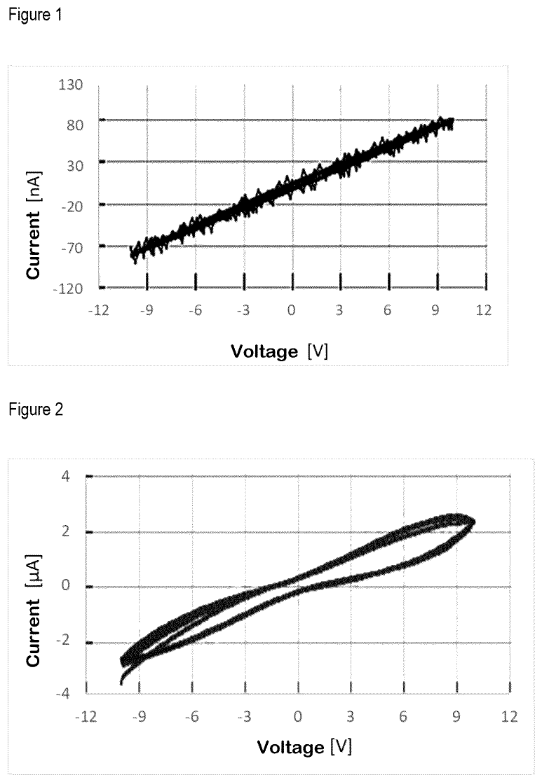

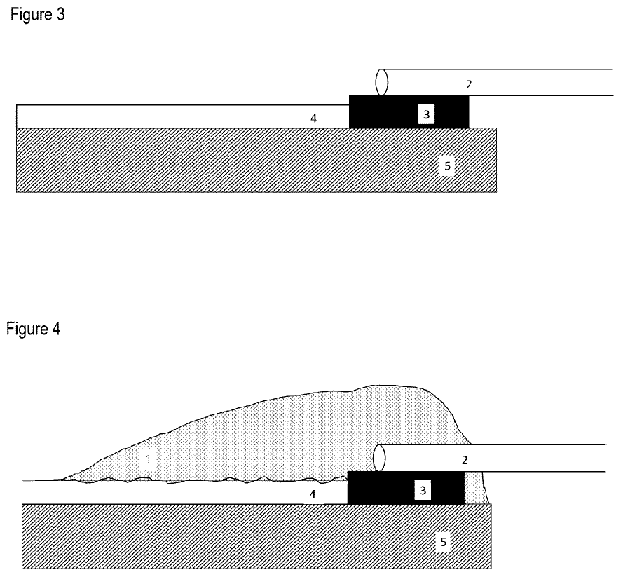

### DESCRIPTION OF AN EMBODIMENT

The invention will now be explained in more detail below using non-limiting examples.

### EXAMPLES

### Example 1

| Glass | % by | Glass | % by | Glass | % by |
|---|---|---|---|---|---|
| composition 1 | wt | composition 2 | wt | composition 3 | wt |
| SiO₂ | 47.7 | SiO₂ | 46.3 | SiO₂ | 30.2 |
| Al₂O₃ | 11.9 | Bi₂O₃ | 10.6 | Al₂O₃ | 14.6 |
| B₂O₃ | 10.8 | B₂O₃ | 8.8 | La₂O₃ | 13.9 |
| ZnO | 7.8 | ZnO | 8.1 | B₂O₃ | 12.8 |
| CoO | 5.8 | Al₂O₃ | 6.7 | ZnO | 11.2 |
| SrO | 5.8 | SrO | 6.1 | CaO | 4.4 |
| K₂O | 3.3 | CoO | 5.2 | CoO | 3.1 |
| BaO | 3.0 | K₂O | 3.4 | Nb₂O | 2.4 |
| Bi₂O₃ | 2.6 | BaO | 3.2 | K₂O | 12.2 |
| Na₂O | 1.0 | MgO | 1.1 | WO₃ | 1.7 |
| CaO | 0.2 | Na₂O | 1.0 | ZrO₂ | 1.0 |
| MgO | 0.1 | CaO | 0.2 | TiO₂ | 1.0 |
| Fe₂O₃ | 0.1 | Fe₂O₃ | 0.1 | Na₂O | 0.3 |
| TiO₂ | 0.0 | TiO₂ | 0.0 | MgO | 0.1 |
| Li₂O | 0.0 | Li₂O | 0.0 | BaO | 0.1 |
| ZrO₂ | 0.0 | ZrO₂ | 0.0 | Fe₂O₃ | 0.1 |
| F | 0.0 | PbO | 0.0 | Li₂O | 0.0 |
| PbO | 0.0 | La₂O₃ | 0.0 | PbO | 0.0 |
| La₂O₃ | 0.0 | F | 0.0 | Bi₂O₃ | 0.0 |
| Nb₂O | 0.0 | Nb₂O | 0.0 | F | 0.0 |
| WO₃ | 0.0 | WO₃ | 0.0 | SrO | 0.0 |

### Example 2

| Glass | % by | Glass | % by | Glass | % by | Glass | % by | Glass | % by |
|---|---|---|---|---|---|---|---|---|---|
| composition 4 | wt | composition 5 | wt | composition 6 | wt | composition 7 | wt | composition 8 | wt |
| SiO₂ | 47.4 | SiO₂ | 51.5 | SiO₂ | 46.3 | SiO₂ | 61.8 | SiO₂ | 59.1 |
| Al₂O₃ | 15.2 | Al₂O₃ | 17.8 | Al₂O₃ | 17.5 | Al₂O₃ | 13.8 | Al₂O₃ | 12.9 |
| ZnO | 12.0 | ZnO | 8.9 | B₂O₃ | 12.6 | B₂O₃ | 7.9 | B₂O₃ | 10.2 |
| CaO | 5.7 | CaO | 6.7 | CaO | 6.9 | ZnO | 4.3 | ZnO | 5.1 |
| B₂O₃ | 4.8 | B₂O₃ | 5.4 | ZnO | 4.6 | Bi₂O₃ | 4.3 | Na₂O | 4.4 |
| Bi₂O₃ | 4.3 | K₂O | 14.9 | Bi₂O₃ | 3.6 | CoO | 3.1 | Bi₂O₃ | 4.3 |
| K₂O | 4.1 | Li₂O | 4.1 | CoO | 3.1 | Na₂O | 2.4 | CoO | 3.1 |
| Li₂O | 3.5 | Na₂O | 0.4 | K₂O | 2.7 | K₂O | 1.9 | BaO | 0.8 |
| CoO | 3.2 | Fe₂O₃ | 0.1 | Na₂O | 12.2 | CaO | 0.5 | CaO | 0.1 |
| Na₂O | 0.3 | MgO | 0.1 | Fe₂O₃ | 0.3 | Fe₂O₃ | 0.1 | Fe₂O₃ | 0.0 |
| Fe₂O₃ | 0.1 | TiO₂ | 0.0 | MgO | 10.2 | ZrO₂ | 0.0 | MgO | 0.0 |
| MgO | 0.1 | PbO | 0.0 | TiO₂ | 0.1 | MgO | 0.0 | K₂O | 0.0 |
| TiO₂ | 0.0 | ZrO₂ | 10.0 | ZrO₂ | 0.0 | TiO₂ | 0.0 | TiO₂ | 0.0 |
| ZrO₂ | 0.0 | BaO | 0.0 | Li₂O | 0.0 | PbO | 0.0 | ZrO₂ | 0.0 |
| PbO | 0.0 | Bi₂O₃ | 0.0 | PbO | 10.0 | BaO | 0.0 | PbO | 0.0 |
| BaO | 0.0 | CoO | 0.0 | BaO | 0.0 | La₂O₃ | 0.0 | La₂O₃ | 0.0 |
| La₂O₃ | 0.0 | La₂O₃ | 0.0 | La₂O₃ | 0.0 | Li₂O | 0.0 | Li₂O | 0.0 |
| F | 0.0 | F | 0.0 | F | 0.0 | F | 0.0 | F | 0.0 |
| Nb₂O | 0.0 | Nb₂O | 0.0 | Nb₂O | 0.0 | Nb₂O | 0.0 | Nb₂O | 0.0 |
| SrO | 10.0 | SrO | 10.0 | SrO | 0.0 | SrO | 0.0 | SrO | 0.0 |
| WO3 | 0.0 | WO₃ | 0.0 | WO₃ | 0.0 | WO₃ | 0.0 | WO₃ | 0.0 |

The glass compositions 1 to 3 in accordance with Example 1 are lead-free and have a low lithium and sodium content. They have no critical crack formation upon breaking and exhibit only a small polarization effect.

The glass compositions 4 to 8 in accordance with Example 2 are in fact lead-free and have no critical crack formation upon breaking, however they exhibit an undesirable high polarization effect.

The results of the polarization measurement and the crack formation upon breaking of the respective glass composition are summarized in the following tables in order to provide a better overview:

| Glass | | | Low lithium | No critical crack |
|---|---|---|---|---|
| com- | Lead- | Polarization | and sodium | formation upon |
| position | free | effect | content | breaking |
| 1 | + | − | + | + |
| 2 | + | − | + | + |
| 3 | + | − | + | + |
| 4 | + | + | − | + |
| 5 | + | + | − | + |
| 6 | + | + | − | + |
| 7 | + | + | − | + |
| 8 | + | + | − | + |

The polarization effect of compositions 1 to 8 was determined in accordance with the described measurement method, wherein the respective compositions were measured in connection with a Pt 1000 sensor. The respectively measured mean values from 2 temperature sensors are given with the specified glass composition.

| Glass composition | Polarization effect at 500 °C/K |
|---|---|
| 1 | <0.1 |
| 2 | <0.1 |
| 3 | <0.05 |
| 4 | 1.52 |
| 8 | 0.76 |
| 6 | 0.57 |
| 7 | 1.72 |
| 8 | 7.07 |

The compositions 1 to 3 in accordance with the invention have a low lithium and sodium content and a low polarization effect.

In contrast, compositions 4 and 5 have an increased lithium and sodium content and exhibit a considerable polarization effect. Similarly, the lithium-free compositions 6 to 8 exhibit an increased polarization effect, because these compositions have an increased sodium content.

### Example 3

Furthermore, the insulation resistances between two conductive wires strain-relieved with a glass composition were measured at a temperature sensor without a continuous strip conductor. It was shown that the insulation resistances of the glass compositions 1, 2 and 3 reduce considerably with a temperature change of 500° C. to 550° C.

| Glass | Insulation resistance | Insulation resistance |
|---|---|---|
| composition | at 500 °C/MΩ | at 550 °C/MΩ |
| 1 | 55 | 33 |
| 2 | 42 | 23 |
| 3 | 288 | 109 |

1-15. (canceled)

16. A glass composition for relieving strain in connection wires on passive components on an inorganic substrate, wherein the glass composition comprises SiO₂, Al₂O₃, B₂O₃ and ZnO, wherein the glass composition further comprises less than 1000 ppm lead and wherein the glass composition comprises less than 2% by weight Na, less than 0.2% by weight Li, and/or less than 2% by weight as a sum of Na and Li, respectively measured by means of ICP, and with respect to a total weight of the glass composition.

17. The glass composition as claimed in claim 16, wherein the glass composition comprises from 20 to 55% by weight silicon dioxide, from 5 to 15% by weight boron oxide, and from 4 to 18% by weight aluminum oxide, with respect to the total weight of the glass composition.

18. The glass composition as claimed in claim 16, wherein the glass composition comprises:
from 35 to 55% by weight silicon dioxide,
from 9 to 14% by weight boron oxide,
from 4 to 7% by weight strontium oxide,
from 2 to 5% by weight potassium oxide,
or
from 35 to 55% by weight silicon dioxide,
from 8 to 15% by weight bismuth oxide,
from 6 to 11% by weight boron oxide,
from 4 to 8% by weight strontium oxide,
from 2 to 6% by weight potassium oxide,
or
from 20 to 55% by weight silicon oxide and lanthanum oxide,
from 11 to 14% by weight boron oxide,
from 3 to 6% by weight calcium oxide,
respectively with respect to the total weight of the glass composition.

19. The glass composition as claimed in claim 16, wherein the glass composition comprises less than 1.5% by weight as the sum of Na and Li, respectively determined by means of ICP, with respect to the total weight of the glass composition.

20. The glass composition as claimed in claim 16, wherein the glass composition is electrically insulating at an applied electric field strength of at least 3 V/cm at 550° C.

21. A passive component comprising the connection wires and the inorganic substrate, wherein the connection wires are strain-relieved by the glass composition as claimed in claim 16.

22. The passive component as claimed in claim 21, wherein the passive component is obtained by singulation, wherein the singulation comprises breaking.

23. The passive component as claimed in claim 21, wherein the passive component is a temperature sensor, which complies with a range of validity of a tolerance class F0.3 (B) at a temperature of −70° C. to 500° C.

24. The passive component as claimed in claim 21, wherein at least one respective end of at least two connection wires is encased at least in sections by a contiguous glass element formed by the glass composition.

25. The passive component as claimed in claim 24, wherein the at least one respective end of the at least two connection wires are positioned in the glass element substantially parallel with respect to each other.

26. The passive component as claimed in claim 24, wherein the at least one respective end of the at least two connection wires have a respective length of at least 0.3 mm.

27. A method for production of the passive component in accordance with claim 21, the method comprising the steps of:
providing the inorganic substrate on which a plurality of structures are disposed,
forming predetermined breaking points in the inorganic substrate between the plurality of structures,
attaching at least one of the connection wires to each of the structures,
covering the connection wires by applying a contiguous glass element over the plurality of structures, and
singulation of the passive component by breaking the inorganic substrate and the contiguous glass element at the predetermined breaking points.

28. A passive component obtained by the method as claimed in claim 27.

29. A use of the glass composition as claimed in claim 16 for relief of strain in the connection wires on the passive components.

30. A use as claimed in claim 29, wherein the passive components have been obtained by singulation, wherein the singulation comprises breaking.
